(19) United States
(12) Patent Application Publication
(10) Pub. No.: US 2026/0278937 A1
(43) Pub. Date: Sep. 17, 2026

(54) PASSIVE ROOM ENROLLMENT

(71) Applicant: Apple Inc., Cupertino, CA (US)

(72) Inventors: Rui Lin, Cupertino, CA (US); Benjamin S. Phipps, San Francisco, CA (US); Qian Wang, Sunnyvale, CA (US); Sanjana Wadhwa, San Francisco, CA (US)

(21) Appl. No.: 19/555,292

(22) Filed: Mar. 3, 2026

Related U.S. Application Data
(60) Provisional application No. 63/772,166, filed on Mar. 14, 2025.

(51) Int. Cl. G06T 17/20; G06T 7/13

(52) U.S. Cl. CPC G06T 17/20; G06T 7/13; G06T 2207/20164; G06T 2207/30168

(57) ABSTRACT

In one implementation, a method of generating a mesh of a physical environment is performed by a device including an image sensor, one or more processors, and non-transitory memory. The method includes capturing, using the image sensor, a plurality of images of a physical environment. The method includes detecting, in the plurality of images, a plurality of features. The method includes determining an enrollment score based on a number of the plurality of images and a number of the plurality of features. The method includes, in response to determining that the enrollment score is greater than a threshold, generating a mesh of the physical environment based on the plurality of images.

### CROSS-REFERENCE TO RELATED APPLICATIONS

This application claims priority to U.S. Provisional Patent App. No. 63/772,166, filed on Mar. 14, 2025, which is hereby incorporated by reference in its entirety.

### TECHNICAL FIELD

The present disclosure generally relates to systems, methods, and devices of passively generating a mesh of a physical environment.

### BACKGROUND

In various implementations, an electronic device generates a mesh of a physical environment based on images of the physical environment. Further, the electronic device can store the mesh (e.g., of a room) in association with an identifier of the physical environment (e.g., a name) to perform “room enrollment.” However, room enrollment typically requires initiation of the process by a user and requires the user to follow instructions to ensure that a complete and accurate mesh is generated.

### SUMMARY

Various implementations disclosed herein include devices, systems, and methods for generating a mesh of a physical environment. In various implementations, the method is performed by a device including an image sensor, non-transitory memory, and one or more processors. The method includes capturing, using the image sensor, a plurality of images of a physical environment. The method includes detecting, in the plurality of images, a plurality of features. The method includes determining an enrollment score based on a number of the plurality of images and a number of the plurality of features. The method includes, in response to determining that the enrollment score is greater than a threshold, generating a mesh of the physical environment based on the plurality of images.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a block diagram of an example operating environment in accordance with some implementations.

FIGS. 2A–2I illustrate a plurality of images captured by an image sensor of an electronic device and a plurality of images displayed by a display of the electronic device during an active enrollment process in accordance with some implementations.

FIGS. 3A–3H illustrate a plurality of images captured by an image sensor of an electronic device and a plurality of images displayed by a display of the electronic device during a passive enrollment process in accordance with some implementations.

FIG. 4 is a flowchart representation of a method of generating a mesh of a physical environment in accordance with some implementations.

FIG. 5 is a block diagram of an example controller in accordance with some implementations.

FIG. 6 is a block diagram of an example electronic device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

As noted above, in various implementations, room enrollment is typically an active process that is initiated by a user and involves the user performing specific actions. As the process is potentially time-consuming, a user may elect to not perform such a procedure. Accordingly, in various implementations, active room enrollment is supplemented or replaced by passive room enrollment in which images of a physical environment are captured while a user is performing other tasks. Unlike active room enrollment, passive room enrollment may not have predefined start and/or end times. For example, an active room enrollment may start upon initiation by a user and end a fixed time later.

Thus, in various implementations, the electronic device performing passive room enrollment determines an enrollment score that is greater than a threshold only when a sufficient number of images have been captured from a variety of positions and/or orientations to ensure an accurate and comprehensive mesh of the physical environment. Once the enrollment score is greater than the threshold, the images of the physical environment are used to generate a mesh of the physical environment which can be stored in association with an identifier of the physical environment.

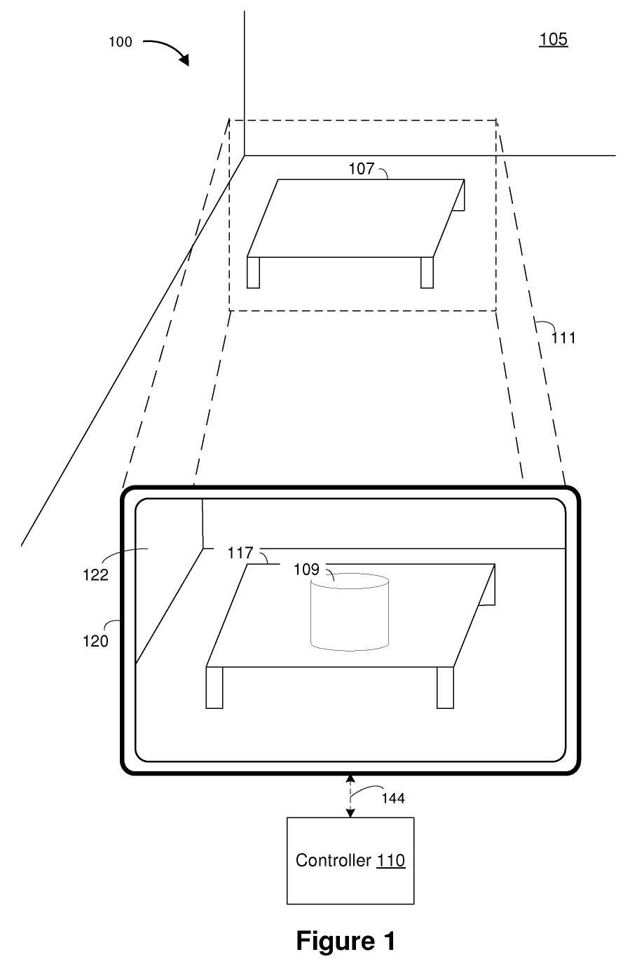

FIG. 1 is a block diagram of an example operating environment 100 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating environment 100 includes a controller 110 and an electronic device 120.

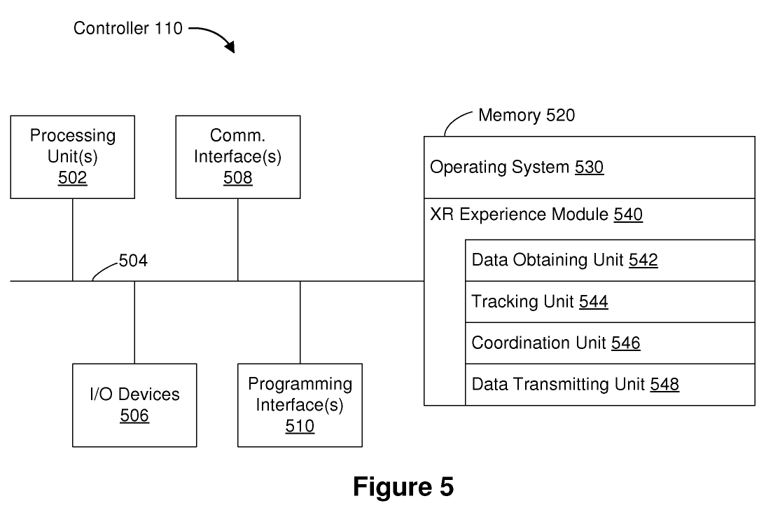

In some implementations, the controller 110 is configured to manage and coordinate an XR experience for the user. In some implementations, the controller 110 includes a suitable combination of software, firmware, and/or hardware. The controller 110 is described in greater detail below with respect to FIG. 5. In some implementations, the controller 110 is a computing device that is local or remote relative to the physical environment 105. For example, the controller 110 is a local server located within the physical environment 105. In another example, the controller 110 is a remote server located outside of the physical environment 105 (e.g., a cloud server, central server, etc.). In some implementations, the controller 110 is communicatively coupled with the electronic device 120 via one or more wired or wireless communication channels 144 (e.g., BLUETOOTH, IEEE 802.11x, IEEE 802.16x, IEEE 802.3x, etc.). In another example, the controller 110 is included within the enclosure of the electronic device 120. In some implementations, the functionalities of the controller 110 are provided by and/or combined with the electronic device 120.

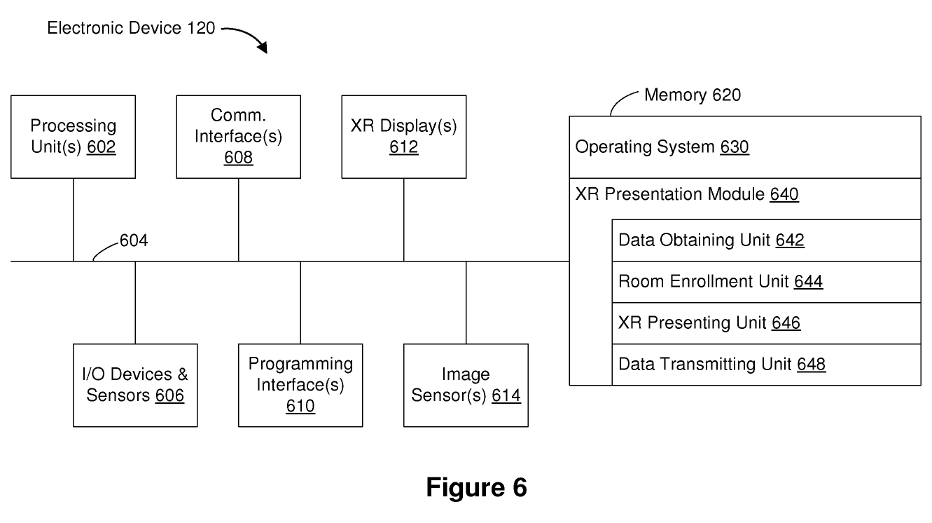

In some implementations, the electronic device 120 is configured to provide the XR experience to the user. In some implementations, the electronic device 120 includes a suitable combination of software, firmware, and/or hardware. According to some implementations, the electronic device 120 presents, via a display 122, XR content to the user while the user is virtually or physically present within the physical environment 105 that includes a table 107 within the field-of-view 111 of the electronic device 120. As such, in some implementations, the user holds the electronic device 120 in his/her hand(s). In some implementations, while providing XR content, the electronic device 120 is configured to display an XR object (e.g., an XR cylinder 109) and to enable video pass-through of the physical environment 105 (e.g., including a representation 117 of the table 107) on a display 122. The electronic device 120 is described in greater detail below with respect to FIG. 6.

In some implementations, the user wears the electronic device 120 on his/her head. For example, in some implementations, the electronic device includes a head-mounted system (HMS), head-mounted device (HMD), or head-mounted enclosure (HME). As such, the electronic device 120 includes one or more XR displays provided to display the XR content. For example, in various implementations, the electronic device 120 encloses the field-of-view of the user. In some implementations, the electronic device 120 is a handheld device (such as a smartphone or tablet) configured to present XR content, and rather than wearing the electronic device 120, the user holds the device with a display directed towards the field-of-view of the user and a camera directed towards the physical environment 105. In some implementations, the handheld device can be placed within an enclosure that can be worn on the head of the user. In some implementations, the electronic device 120 is replaced with an XR chamber, enclosure, or room configured to present XR content in which the user does not wear or hold the electronic device 120.

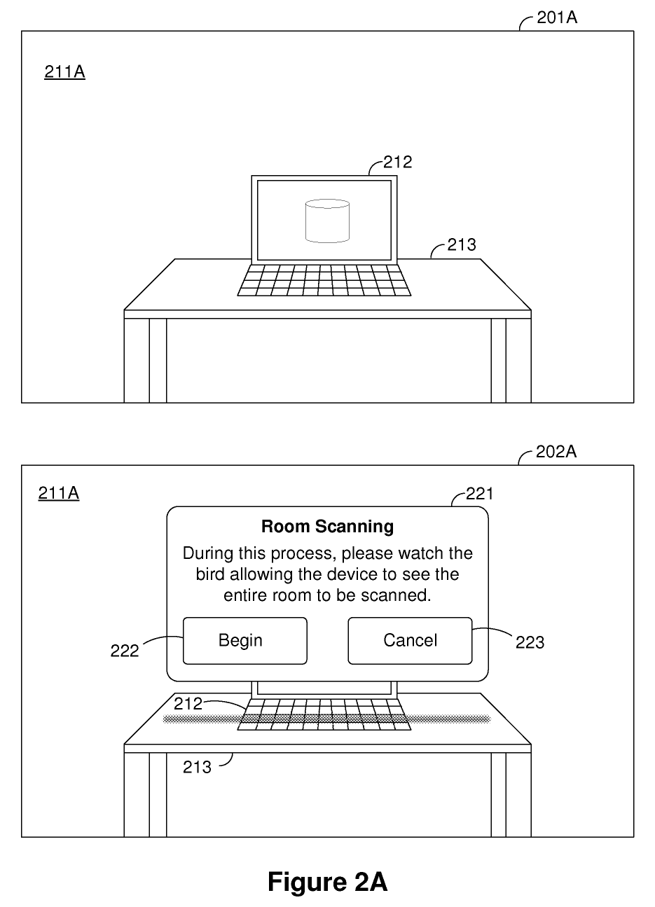

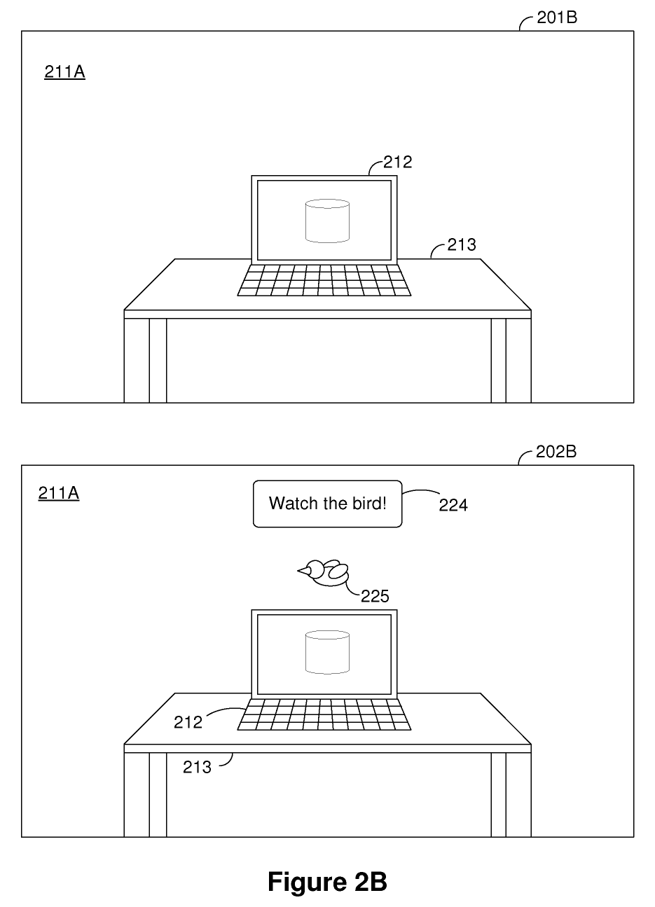

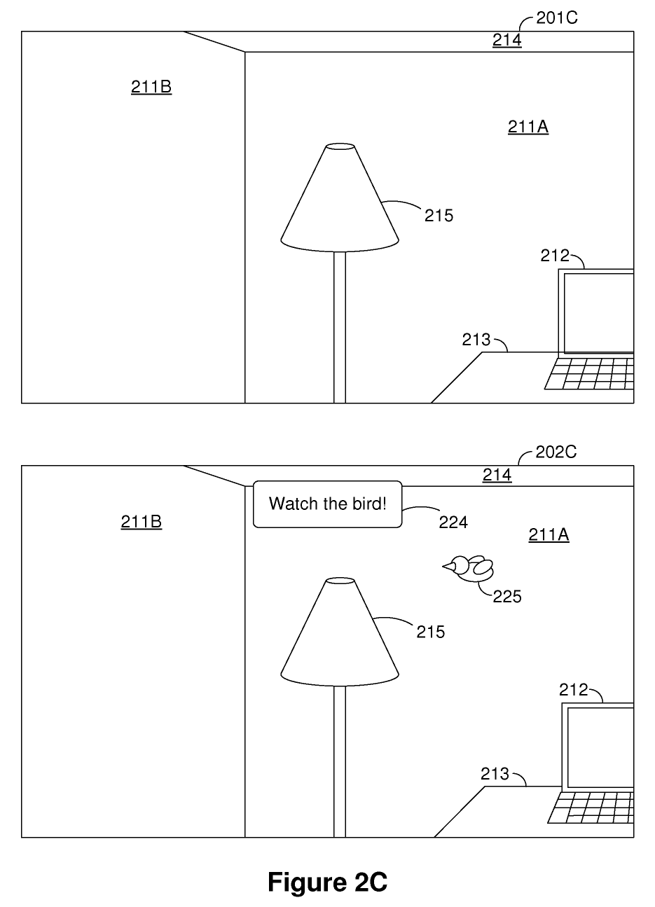

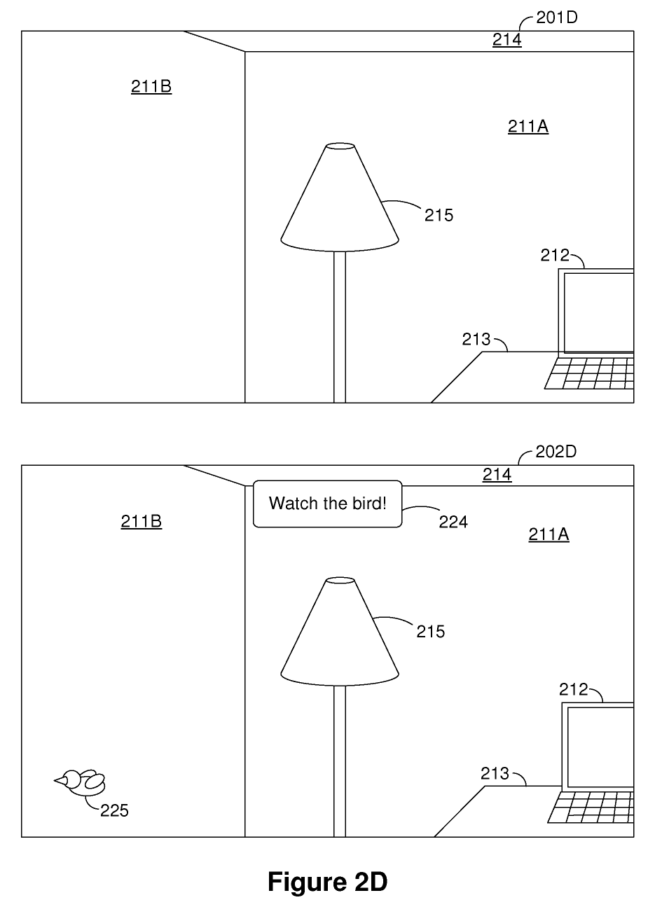

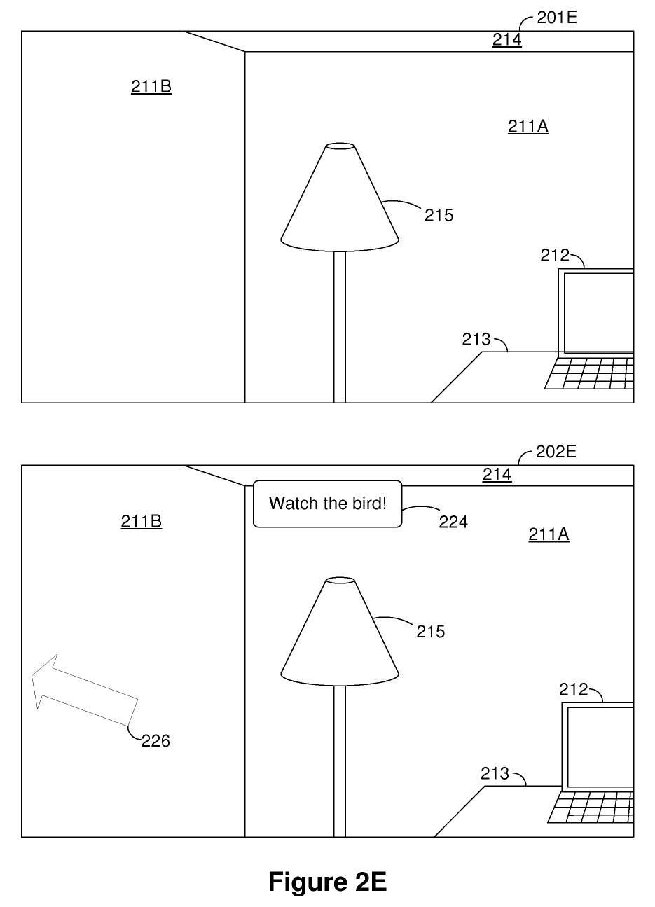

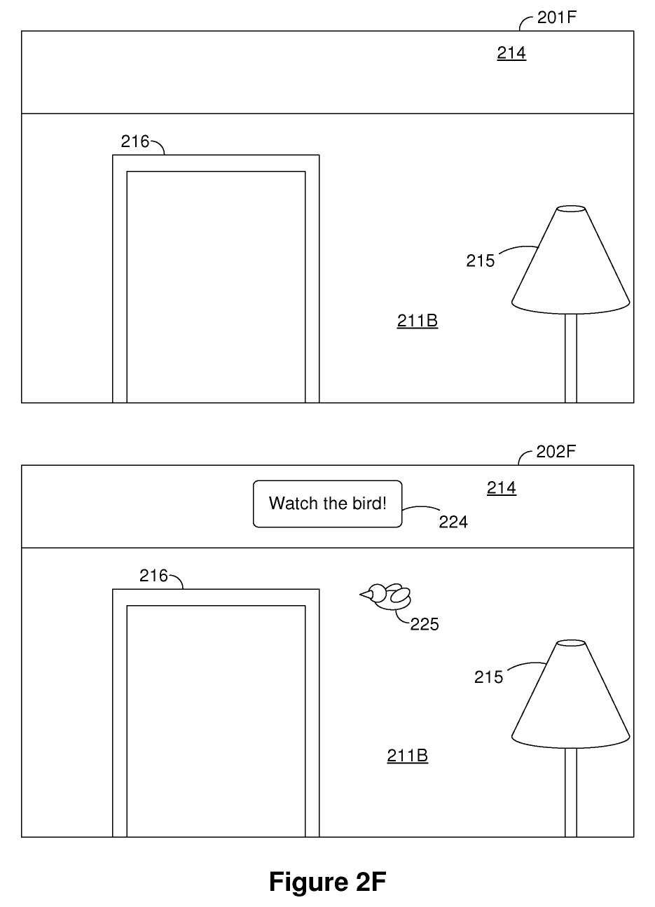

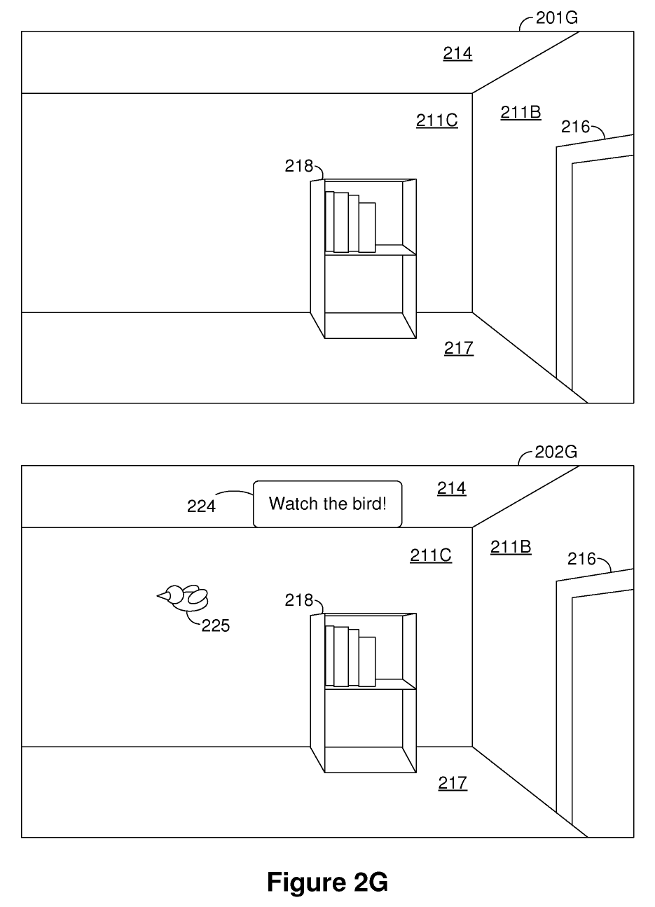

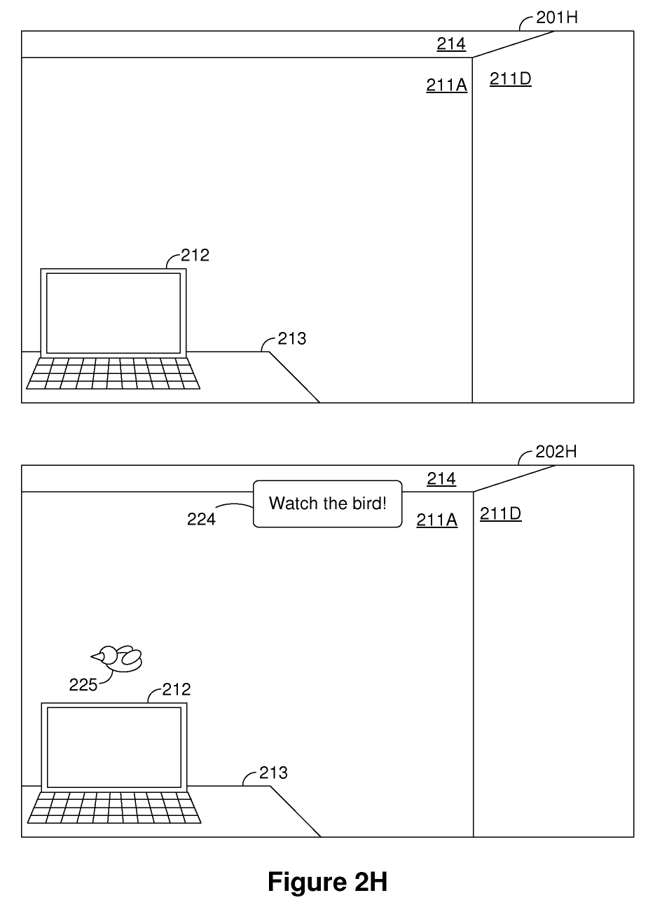

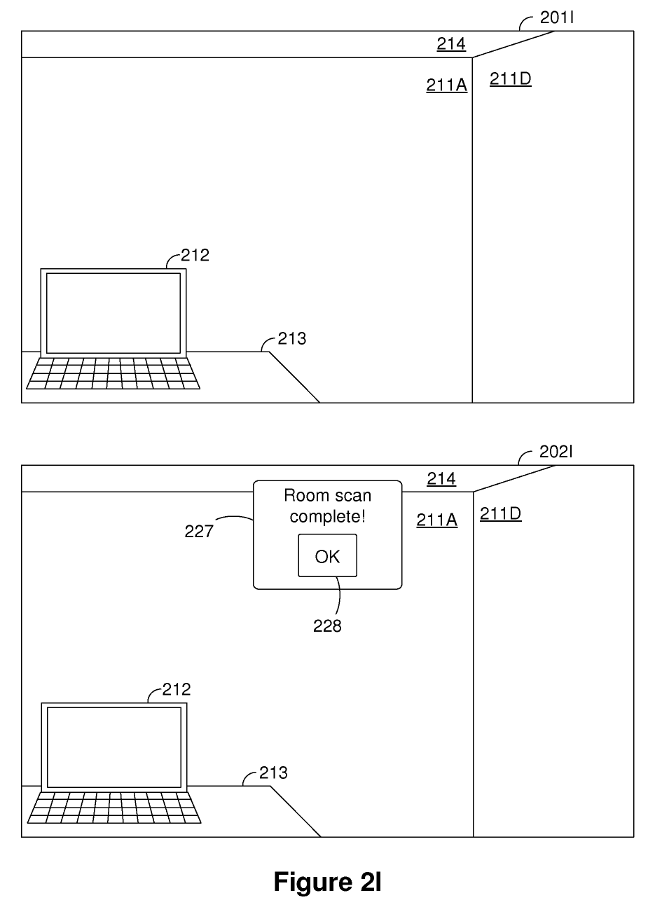

FIGS. 2A–2I illustrate a plurality of images of a physical environment 201A–201I of an office captured by an image sensor of an electronic device. Further, FIGS. 2A–2I further illustrate a plurality of images of an XR environment 202A–202I displayed, at least in part, by a display of the electronic device. In various implementations, the electronic device includes multiple displays (e.g., a left display positioned in front of a left eye of a user and a right display positioned in front of a right eye of the user) configured to provide a stereoscopic view of the XR environment. For ease of illustration, FIGS. 2A–2I illustrate the images of the XR environment 202A–202I as presented on a single one of the multiple displays.

In various implementations, the images of the physical environment 201A–201I are captured (and the images of the XR environment 202A–202I are displayed) during a series of time periods. In various implementations, each time period is an instant, a fraction of a second, a few seconds, a few hours, a few days, or any length of time.

The images of the XR environment 202A–202I are generated by compositing virtual content on top of the images of the physical environment 201A–201I. Accordingly, physical objects captured in the images of the physical environment 201A–201I are also displayed in the images of the XR environment 202A–202I. Further, at least some of the images of the XR environment 202A–202I include virtual objects.

In various implementations, certain objects are presented at a location in the XR environment, e.g., at a location defined by three coordinates in a three-dimensional (3D) XR coordinate system. Accordingly, when the electronic device moves in the XR environment (e.g., changes either position and/or orientation), the objects are moved on the display of the electronic device, but retain their (possibly time-dependent) location in the XR environment. Such virtual objects that, in response to motion of the electronic device, move on the display, but retain their position in the XR environment are referred to as world-locked objects. In various implementations, certain virtual objects are displayed at locations on the display such that when the electronic device moves in the XR environment, the objects are stationary on the display on the electronic device. Such virtual objects that, in response to motion of the electronic device, retain their location on the display are referred to as head-locked objects or display-locked objects.

FIG. 2A illustrates a first image of the physical environment 201A captured during a first time period and a first image of the XR environment 202A displayed during the first time period. The first image of the physical environment 201A includes a first wall 211A, a laptop 212, and a desk 213. Accordingly, the first image of the XR environment 202A also includes the first wall 211A, the laptop 212, and the desk 213. Additionally, the first image of the XR environment 202A includes a room enrollment initiation window 221 floating in the XR environment in front of the laptop 212. The room enrollment initiation window 221 is a world-locked virtual object. The room enrollment initiation window 221 includes a begin affordance 222 and a cancel affordance 223. Upon selection of the begin affordance 222, an room enrollment process is initiated. Upon selection of the cancel affordance 223, the room enrollment initiation window 221 is removed from the XR environment.

FIG. 2B illustrates a second image of the physical environment 201B captured during a second time period and a second image of the XR environment 202B displayed during the second time period. Between the first time period and the second time period, the user has selected the begin affordance 222. The second image of the physical environment 201B includes the first wall 211A, the laptop 212, and the desk 213. Accordingly, the second image of the XR environment 202B also includes the first wall 211A, the laptop 212, and the desk 213. As part of the room enrollment process, the second image of the physical environment 201B is stored to be used for generating a mesh of the physical environment.

In response to the user selecting the begin affordance 222, the second image of the XR environment 202B does not include the room enrollment initiation window 221, but instead includes an instructions window 224 and a virtual bird 225. The instructions window 224 is a display-locked virtual object and the virtual bird 225 is a world-locked virtual object that moves around the physical environment.

FIG. 2C illustrates a third image of the physical environment 201C captured during a third time period and a third image of the XR environment 202C displayed during the third time period. Between the second time period and the third time period, the virtual bird 225 has moved to a new location in the XR environment and, in accordance with the instructions displayed in the instructions window 224, the user has changed position and/or orientation to realize a different perspective.

The third image of the physical environment 201C includes the first wall 211A, the laptop 212, and the desk 213, but also includes a second wall 211B, a ceiling 214, and a lamp 215. Accordingly, the third image of the XR environment 202C also includes the first wall 211A, the second wall 211B, the laptop 212, the desk 213, the ceiling 214, and the lamp 215. As part of the room enrollment process, the third image of the physical environment 201C is stored to be used for generating a mesh of the physical environment. The third image of the XR environment 202C includes the instructions window 224 at an unchanged location on the display and the virtual bird 225 at a changed location on the display.

FIG. 2D illustrates a fourth image of the physical environment 201D captured during a fourth time period and a fourth image of the XR environment 202D displayed during the fourth time period. Between the third time period and the fourth time period, the virtual bird 225 has moved to a new location in the XR environment but, contrary to the instructions displayed in the instructions window 224, the user has not changed position and/or orientation to realize a different perspective.

Thus, the fourth image of the physical environment 201D is identical to the third image of the physical environment 201C and the fourth image of the XR environment 202D differs from the third image of the XR environment 202C only by a change in the position of the virtual bird 225. As part of the room enrollment process, the fourth image of the physical environment 201D is stored to be used for generating a mesh of the physical environment.

FIG. 2E illustrates a fifth image of the physical environment 201E captured during a fifth time period and a fifth image of the XR environment 202E displayed during the fifth time period. Between the fourth time period and the fifth time period, the virtual bird 225 has moved to a new location in the XR environment but, contrary to the instructions displayed in the instructions window 224, the user has not changed position and/or orientation to realize a different perspective.

Thus, the fifth image of the physical environment 201E is identical to the fourth image of the physical environment 201D and the fifth image of the XR environment 202E differs from the fourth image of the XR environment 202D only by replacement of the virtual bird 225 with an off-screen indicator 226 indicating that the virtual bird 225 is not within the field-of-view of the camera. As part of the room enrollment process, the fifth image of the physical environment 201E is stored to be used for generating a mesh of the physical environment.

FIG. 2F illustrates a sixth image of the physical environment 201F captured during a sixth time period and a sixth image of the XR environment 202F displayed during the sixth time period. Between the fifth time period and the sixth time period, the virtual bird 225 has moved to a new location in the XR environment and, in accordance with the instructions displayed in the instructions window 224, the user has changed position and/or orientation to realize a different perspective.

The sixth image of the physical environment 201F includes the second wall 211B, the ceiling 214, the lamp 215 and a door 216. Accordingly, the sixth image of the XR environment 202F also includes the second wall 211B, the ceiling 214, the lamp 215, and the door 216. As part of the room enrollment process, the sixth image of the physical environment 201F is stored to be used for generating a mesh of the physical environment. The sixth image of the XR environment 202F includes the instructions window 224 at an unchanged location on the display and the virtual bird 225 at a changed location on the display.

FIG. 2G illustrates a seventh image of the physical environment 201G captured during a seventh time period and a seventh image of the XR environment 202G displayed during the seventh time period. Between the sixth time period and the seventh time period, the virtual bird 225 has moved to a new location in the XR environment and, in accordance with the instructions displayed in the instructions window 224, the user has changed position and/or orientation to realize a different perspective.

The seventh image of the physical environment 201G includes the second wall 211B, the ceiling 214, and the door 216, but also includes a third wall 211C, a floor 217, and a bookcase 218. Accordingly, the seventh image of the XR environment 202G also includes the second wall 211B, the ceiling 214, the door 216, the third wall 211C, the floor 217, and the bookcase 218. As part of the room enrollment process, the seventh image of the physical environment 201G is stored to be used for generating a mesh of the physical environment. The seventh image of the XR environment 202G includes the instructions window 224 at an unchanged location on the display and the virtual bird 225 at a changed location on the display.

FIG. 2H illustrates an eighth image of the physical environment 201H captured during an eighth time period and an eighth image of the XR environment 202H displayed during the eighth time period. Between the seventh time period and the eighth time period, the virtual bird 225 has moved to a new location in the XR environment (its original location in the XR environment) and, in accordance with the instructions displayed in the instructions window 224, the user has changed position and/or orientation to realize a different perspective.

The eighth image of the physical environment 201H includes the first wall 211A, the laptop 212, the desk 213, the ceiling 214, and a fourth wall 211D. Accordingly, the eighth image of the XR environment 202H also includes the first wall 211A, the laptop 212, the desk 213, the ceiling 214, and the fourth wall 211D. As part of the room enrollment process, the eighth image of the physical environment 201G is stored to be used for generating a mesh of the physical environment. The eighth image of the XR environment 202H includes the instructions window 224 at an unchanged location on the display and the virtual bird 225 at a changed location on the display.

FIG. 2I illustrates a ninth image of the physical environment 201I captured during a ninth time period and a ninth image of the XR environment 202I displayed during the ninth time period. Between the eighth time period and the ninth time period, in response to the virtual bird 225 reaching its original location in the XR environment, having completed a circuit around the room, the electronic device generates a mesh of the physical environment based on the captured images, e.g., images of the physical environment 201B–201H.

The ninth image of the physical environment 201I is identical to the eighth image of the physical environment 201H and the ninth image of the XR environment 202I differs from the eighth image of the XR environment 202H in that the instructions window 224 and the virtual bird 225 are replaced with a room enrollment completion window 227. The room enrollment completion window 227 is a world-locked virtual object including an affirm affordance 228 which, when selected, removes the room enrollment completion window 227 from the XR environment.

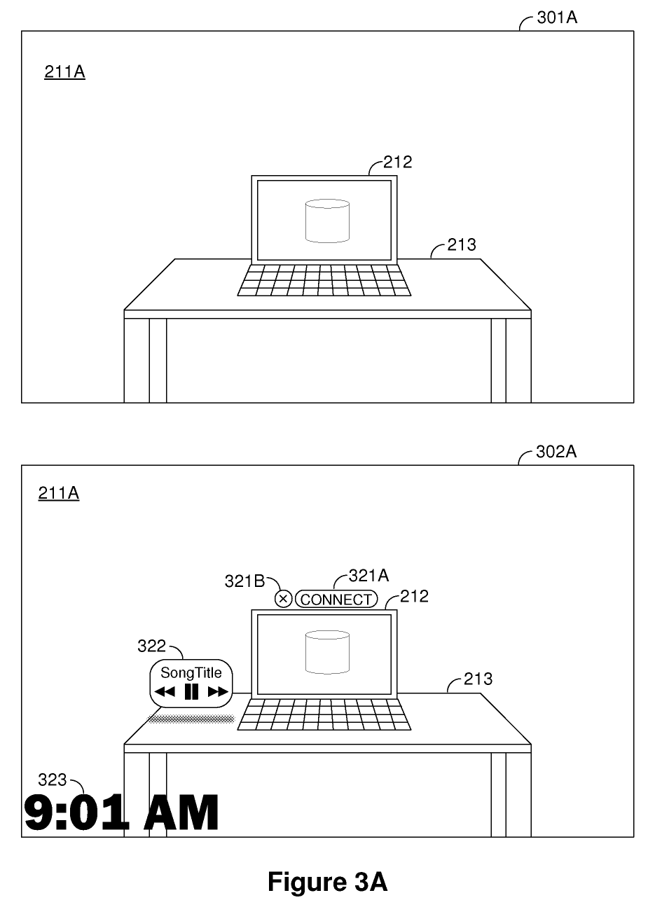

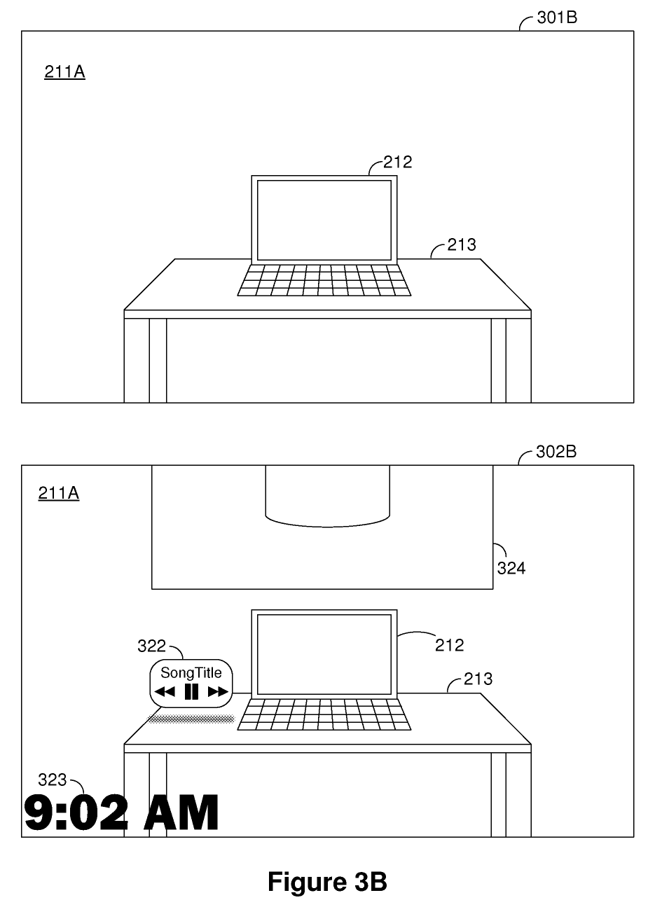

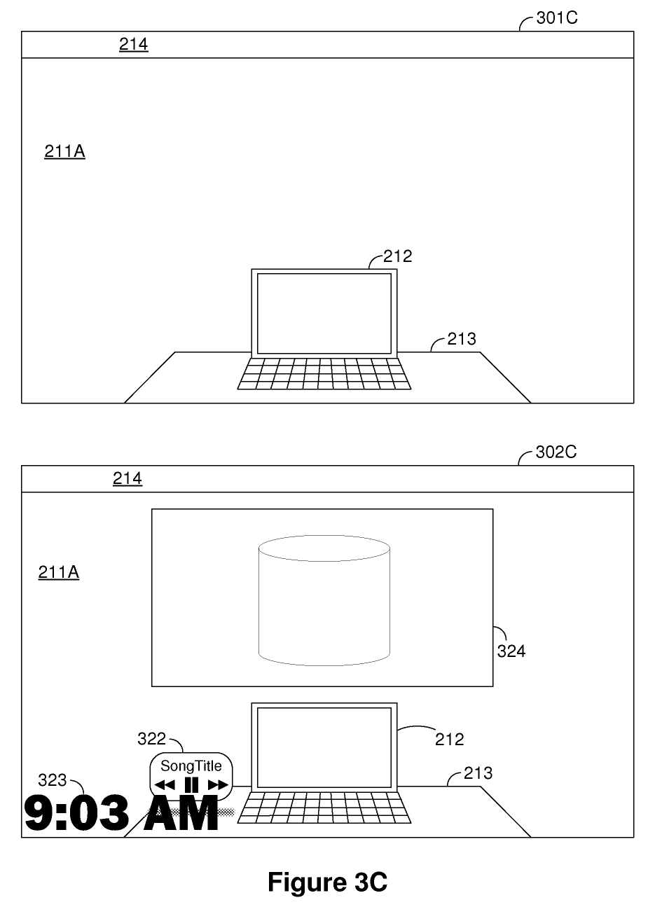

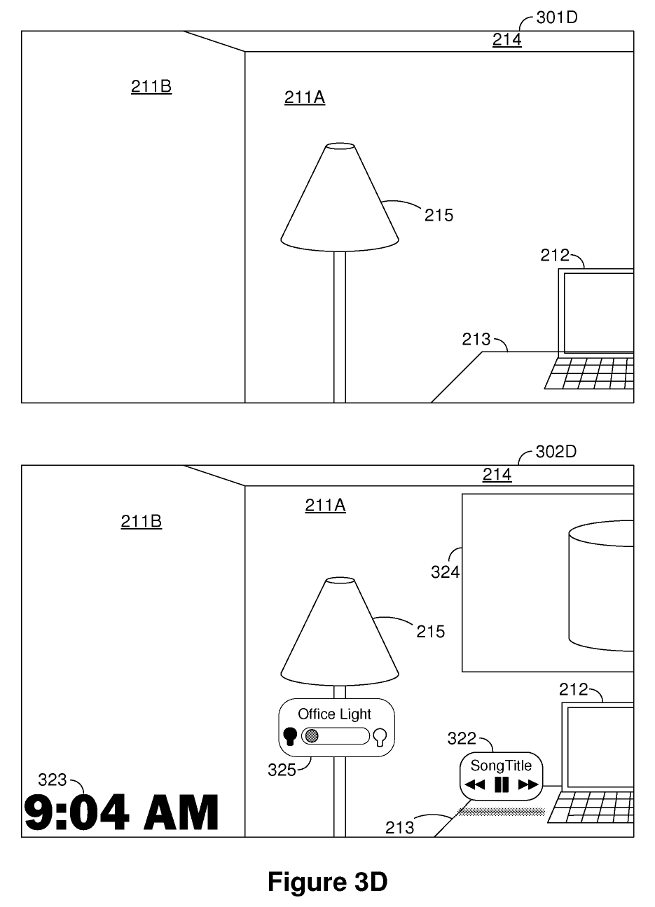

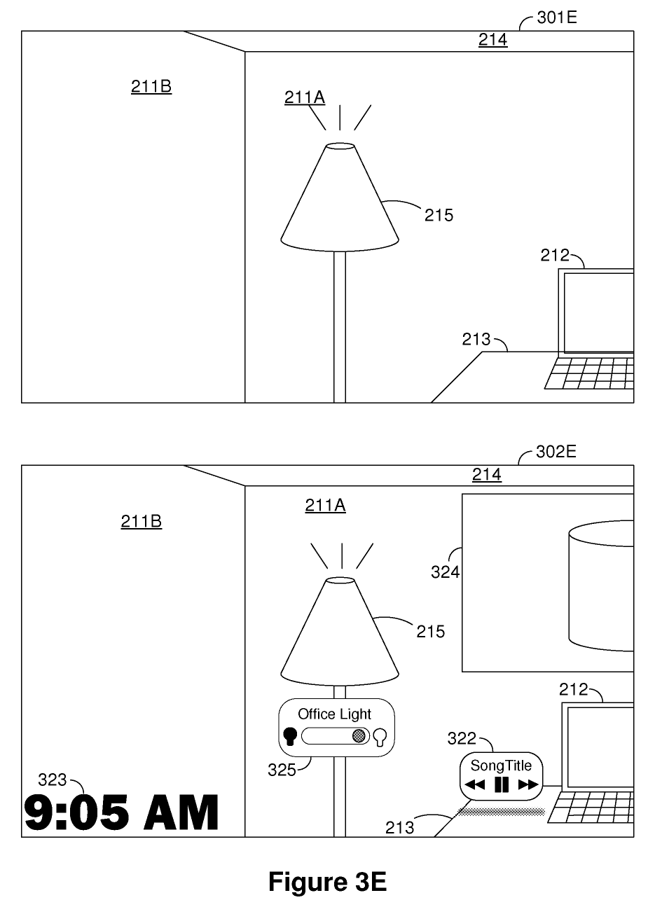

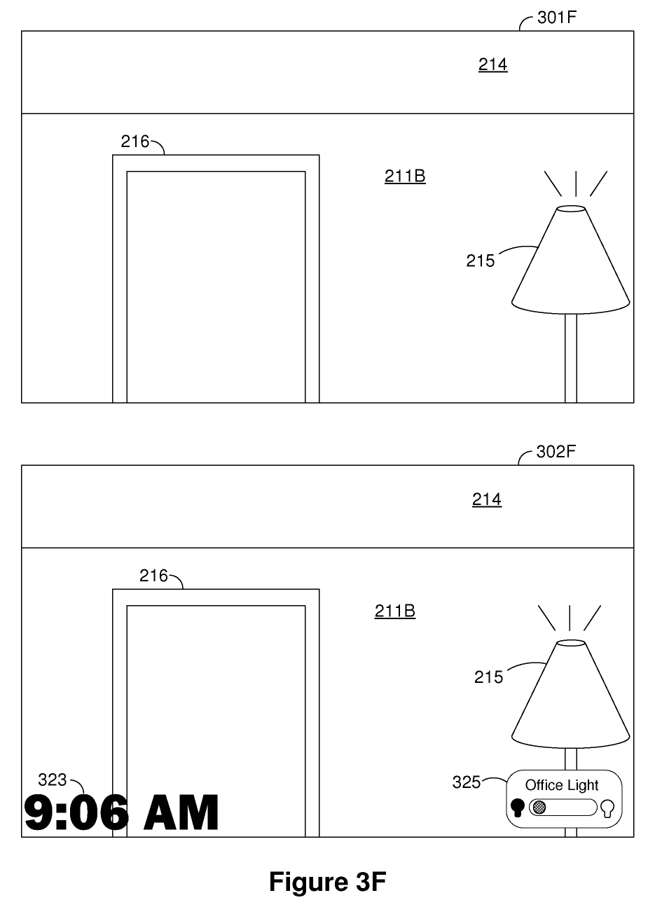

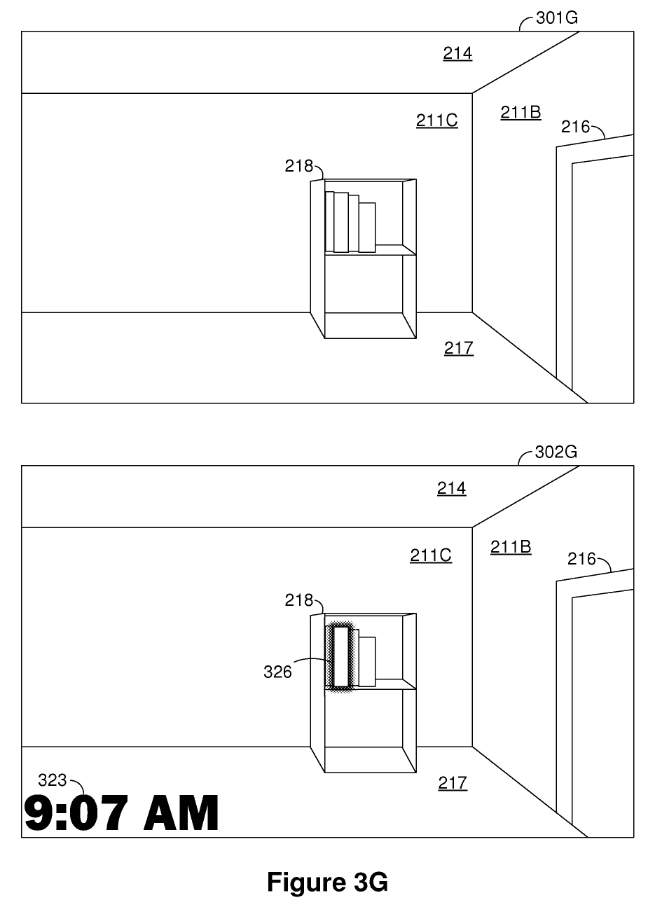

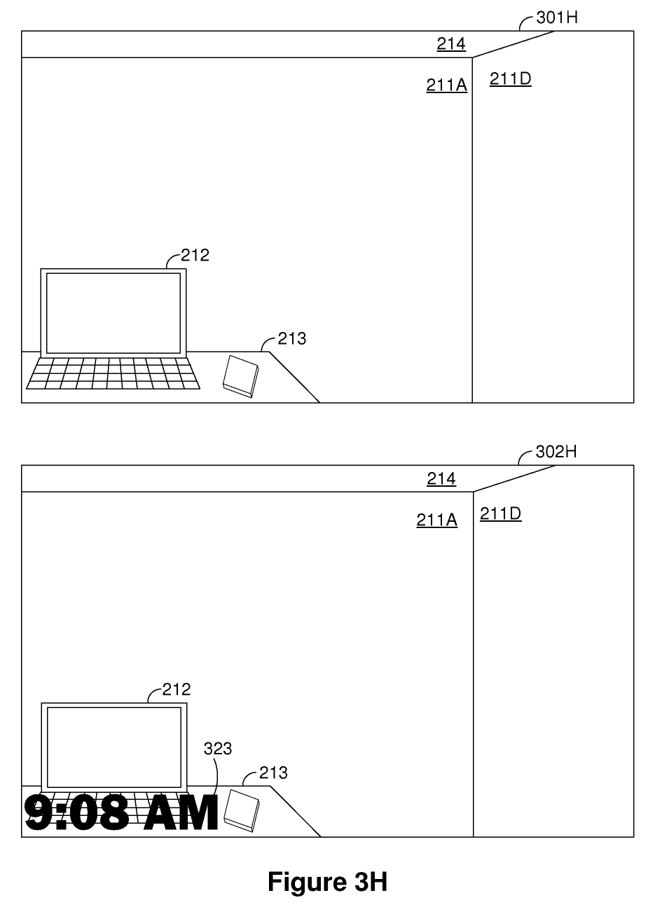

FIGS. 3A–3H illustrate a plurality of images of the physical environment 301A–301H of the office captured by an image sensor of an electronic device. Further, FIGS. 3A–3H further illustrate a plurality of images of the XR environment 302A–302H displayed, at least in part, by a display of the electronic device. As compared to the plurality of images of the XR environment 202A–202I illustrating an active room enrollment process, the plurality of images of the XR environment 302A–302H illustrate a passive room enrollment process.

FIG. 3A illustrates a first image of the physical environment 301A captured during a first time period and a first image of the XR environment 302A displayed during the first time period. The first image of the physical environment 301A includes the first wall 211A, the laptop 212, and the desk 213. Accordingly, the first image of the XR environment 302A also includes the first wall 211A, the laptop 212, and the desk 213. Additionally, the first image of the XR environment 302A includes a connect affordance 321A, a dismiss affordance 321B, a music player window 322, and a virtual clock 323. The connect affordance 321A is a world-locked virtual object displayed in association with the laptop 212 which, when selected (as described below), displays a virtual screen containing the content displayed on the screen of the laptop 212. The dismiss affordance 321B is a world-locked virtual object displayed in association with the laptop 212 which, when selected, removes the connect affordance 321A and the dismiss affordance 321B from the XR environment. The music player window 322 is a world-locked virtual object with which a user can interact to player music from a library. The virtual clock 323 is a display-locked virtual object that indicates the time.

During the first time period, the electronic device stores the first image of the physical environment 301A for a room enrollment process. Further, the electronic device detects, in the first image of the physical environment 301A, a number of features. Each feature may be a point (such as the corner of the desk 213), a line (such as the top edge of the laptop 212), a surface (such as the first wall 211A), or a volume or object (such as the laptop 212). The electronic device determines an enrollment score based on, for example, the number of images stored for the room enrollment process, the number of features detected in those images, and the number of images in which those features are detected. When the enrollment score exceeds a threshold, the electronic device performs the room enrollment process and generates a mesh of the physical environment based on the stored images.

FIG. 3B illustrates a second image of the physical environment 301B captured during a second time period and a second image of the XR environment 302B displayed during the second time period. Between the first time period and the second time period, the user has selected the connect affordance 321A. The second image of the physical environment 301B includes the first wall 211A, the laptop 212, and the desk 213. Accordingly, the second image of the XR environment 302B also includes the first wall 211A, the laptop 212, and the desk 213.

In response to the user selecting the connect affordance 321A, the second image of the XR environment 302B does not include the connect affordance 321A or the dismiss affordance 321B, but instead includes a virtual screen 324. The virtual screen 324 is a world-locked virtual object that displays the content previously displayed by the laptop 212. Further, the second image of the XR environment 302B includes the music player window 322, the virtual clock 323, and the virtual screen 324.

In various implementations, during the second time period, the electronic device stores the second image of the physical environment 301B for the room enrollment process. Further, the electronic device detects, in the second image of the physical environment 301B, a number of features and recalculates the enrollment score. For example, in various implementations, the enrollment score is increased by detecting the same features in multiple images. However, in various implementations, because the perspective of the second image of the physical environment 301B is unchanged from the perspective of the first image of the physical environment 301A (e.g., the pose of the user has not changed), the electronic device does not store the second image of the physical environment 301B for the room enrollment process or detect features within the image. In various implementations, the electronic device determines that the pose of the user has not changed by comparing the second image of the physical environment 301B to the first image of the physical environment 301A. In various implementations, comparing the second image of the physical environment 301B to the first image of the physical environment 301A includes generating a similarity score. The similarity score can be determined using pixel-by-pixel comparison (e.g., subtraction, mean-square error, structural similarity index), histogram comparison, feature-based comparison, and/or deep learning techniques. If the similarity score is above a similarity threshold, the electronic device determines that the pose of the user has not changed.

In various implementations, the electronic device determines that the pose of the user has not changed based on motion data from an inertial measurement unit (IMU). In such a case, in various implementations, the second image of the physical environment 301B is not captured at all to save power in capturing the image using the image sensor or processing the image.

FIG. 3C illustrates a third image of the physical environment 301C captured during a third time period and a third image of the XR environment 302C displayed during the third time period. Between the second time period and the third time period, the user has changed pose to better position the virtual screen 324 within the user’s field-of-view. The third image of the physical environment 301C includes the first wall 211A, the laptop 212, and the desk 213, but also includes the ceiling 214. Accordingly, the third image of the XR environment 302C also includes the first wall 211A, the laptop 212, the desk 213, and the ceiling 214. Further, the third image of the XR environment 302C includes the music player window 322, the virtual clock 323, and the virtual screen 324.

During the third time period, the electronic device stores the third image of the physical environment 301C for the room enrollment process. Further, the electronic device detects, in the third image of the physical environment 301C, a number of features and recalculates the enrollment score. For example, in various implementations, the enrollment score is increased by detecting the ceiling 214 or the edge between the first wall 211A and the ceiling 214.

FIG. 3D illustrates a fourth image of the physical environment 301D captured during a fourth time period and a fourth image of the XR environment 302D displayed during the fourth time period. Between the third time period and the fourth time period, the user has changed pose to position the lamp 215 within the user’s field-of-view (e.g., to turn it on). The fourth image of the physical environment 301D includes the first wall 211A, the laptop 212, the desk 213, the ceiling 214, the second wall 211B, and the lamp 215. Accordingly, the fourth image of the XR environment 302D also includes the first wall 211A, the laptop 212, the desk 213, the ceiling 214, the second wall 211B, and the lamp 215. Further, the fourth image of the XR environment 302D includes the music player window 322, the virtual clock 323, and the virtual screen 324. The fourth image of the XR environment 302D also includes a lamp control window 325 with which a user can interact to turn the lamp 215 on or off. The lamp control window 325 is world-locked virtual object displayed in association with the lamp 215.

During the fourth time period, the electronic device stores the fourth image of the physical environment 301D for the room enrollment process. Further, the electronic device detects, in the fourth image of the physical environment 301D, a number of features and recalculates the enrollment score. In various implementations, the electronic device detects (as a feature) the room corner formed by the intersection of the first wall 211A, the second wall 211B, and the ceiling 214.

FIG. 3E illustrates a fifth image of the physical environment 301E captured during a fifth time period and a fifth image of the XR environment 302E displayed during the fifth time period. Between the fourth time period and the fifth time period, the user has not changed pose, but has interacted with the lamp control window 325 to turn on the lamp 215. Thus, the fifth image of the physical environment 301E still includes the first wall 211A, the laptop 212, the desk 213, the ceiling 214, the second wall 211B, and the lamp 215 and the fifth image of the XR environment 302E also still includes the first wall 211A, the laptop 212, the desk 213, the ceiling 214, the second wall 211B, and the lamp 215. Further, the fifth image of the XR environment 302E still includes the music player window 322, the virtual clock 323, the virtual screen 324, and the lamp control window 325.

In various implementations, during the fifth time period, the electronic device stores the fifth image of the physical environment 301E for the room enrollment process. Further, the electronic device detects, in the fifth image of the physical environment 301E, a number of features and recalculates the enrollment score. For example, in various implementations, the enrollment score is increased by detecting the same features in multiple images. However, in various implementations, because the perspective of the fifth image of the physical environment 301E is unchanged from the perspective of the fourth image of the physical environment 301D (e.g., the pose of the user has not changed), the electronic device does not store the fifth image of the physical environment 301E for the room enrollment process or detect features within the image. Nevertheless, in some embodiments, even though the pose of the user has not changed, the electronic device detects that the fifth image of the physical environment 301E is sufficiently different than the fourth image of the physical environment 301D (e.g., because the lamp 215 is now on) that the fifth image of the physical environment 301E and stores the fifth image of the physical environment 301E for the room enrollment process. For example, in various implementations, the similarity score generated when comparing the fifth image of the physical environment 301E to the fourth image of the physical environment 301D is greater than the similarity threshold even though the pose of the user is unchanged.

FIG. 3F illustrates a sixth image of the physical environment 301F captured during a sixth time period and a sixth image of the XR environment 302F displayed during the sixth time period. Between the fifth time period and the sixth time period, the user has changed pose, standing to retrieve a book from the bookcase 218. The sixth image of the physical environment 301F includes the second wall 211B, the ceiling 214, the lamp 215, and the door 216. Accordingly, the sixth image of the XR environment 302F also includes the second wall 211B, the ceiling 214, the lamp 215, and the door 216. Further, the sixth image of the XR environment 302F includes the virtual clock 323 and the lamp control window 325.

In various implementations, during the sixth time period, the electronic device stores the sixth image of the physical environment 301F for the room enrollment process. Further, the electronic device detects, in the sixth image of the physical environment 301F, a number of features and recalculates the enrollment score.

FIG. 3G illustrates a seventh image of the physical environment 301G captured during a seventh time period and a seventh image of the XR environment 302G displayed during the seventh time period. Between the sixth time period and the seventh time period, the user has changed pose moving towards the bookcase 218. The seventh image of the physical environment 301G includes the second wall 211B, the third wall 211C, the ceiling 214, the door 216, the floor 217, and the bookcase 218. Accordingly, the seventh image of the XR environment 302G also includes the second wall 211B, the third wall 211C, the ceiling 214, the door 216, the floor 217, and the bookcase 218. Further, the seventh image of the XR environment 302G includes the virtual clock 323 and a virtual highlighting 326 of a book the user intends to obtain.

During the seventh time period, the electronic device stores the seventh image of the physical environment 301G for the room enrollment process. Further, the electronic device detects, in the seventh image of the physical environment 301G, a number of features and recalculates the enrollment score.

FIG. 3H illustrates an eighth image of the physical environment 301H captured during an eighth time period and an eighth image of the XR environment 302H displayed during the eighth time period. Between the seventh time period and the eighth time period, the user has changed pose, moving back towards the desk 213. The eighth image of the physical environment 301H includes the first wall 211A, the laptop 212, the desk 213, the ceiling, and the fourth wall 211D. Accordingly, the eighth image of the XR environment 302H also includes the first wall 211A, the laptop 212, the desk 213, the ceiling, and the fourth wall 211D. Further, the seventh image of the XR environment 302G includes the virtual clock 323.

During the eighth time period, the electronic device stores the eighth image of the physical environment 301H for the room enrollment process. Further, the electronic device detects, in the eighth image of the physical environment 301H, a number of features and recalculates the enrollment score. During the eighth time period, the enrollment score exceeds the threshold. Accordingly, the electronic device performs the room enrollment process and generates a mesh of the physical environment based on the stored images.

Thus, FIGS. 2A–2I illustrate an active enrollment process over a prescribed time period that begins with initiation by a user and, at a fixed time thereafter, ends with the electronic device generating a mesh of the physical environment based on images captured during the prescribed time period. In contrast, FIGS. 3A–3I illustrate a passive enrollment process in which images are captured while the user performs other tasks and, when the enrollment score exceeds a threshold, a mesh of the physical environment is generated based on those images.

In various implementations, the passive enrollment process replaces and/or supplements the active enrollment process. For example, in various implementations, if the enrollment score of a passive enrollment process does not exceed the enrollment threshold after some period of time (e.g., 15 minutes), the active enrollment process is recommended. If triggered by the user, the mesh of the physical environment can be generated based on the images captured during the passive enrollment process and the active enrollment process. In various implementations, the active enrollment process can be modified based on the images captured during the passive enrollment process. For example, during the active enrollment process, the user can be instructed to look at regions of the physical environment that have not already been imaged during the passive enrollment process (e.g., by showing the virtual bird 225 in those locations).

In various implementations, the electronic device may take active steps to increase the enrollment score during a passive enrollment process. For example, in various implementations, the electronic device opens new windows in regions of the physical environment that have not been imaged. As another example, while displaying an immersive virtual environment, sounds behind the user can be amplified to encourage the user to turn around, allowing the electronic device to capture images of the physical environment. As another example, the active steps may include displaying a view target (e.g., the virtual bird 225) and/or instructions (e.g., the instructions window 224) encouraging the user to move the electronic device to allow image capture of regions of the physical environment that have not been triggered.

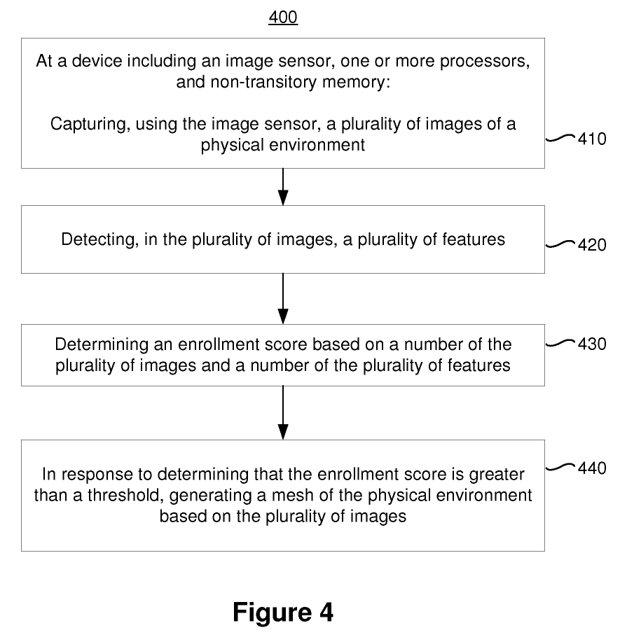

FIG. 4 is a flowchart representation of a method 400 of generating a mesh of a physical environment in accordance with some implementations. In various implementations, the method 400 is performed by an electronic device, such as the electronic device 120 of FIG. 1. In various implementations, the method 400 is performed by a device including an image sensor, one or more processors, and non-transitory memory. In some implementations, the method 400 is performed by processing logic, including hardware, firmware, software, or a combination thereof. In some implementations, the method 400 is performed by a processor executing instructions (e.g., code) stored in a non-transitory computer-readable medium (e.g., a memory).

The method 400 begins, in block 410, with the device capturing, using the image sensor, a plurality of images of a physical environment. In various implementations, the images are captured periodically (e.g., 60 times a second, 30 times a second, 10 times a second, once a second, once every 10 seconds, once every 30 seconds, once every 60 seconds, etc.). In various implementations, the images are captured in response to movement of the device. Thus, in various implementations, capturing the plurality of images includes periodically capturing the plurality of images and, in various implementations, capturing the plurality of images includes capturing the plurality of images in response to detecting motion of the device.

The method 400 continues, in block 420, with the device detecting, in the plurality of images, a plurality of features. In various implementations, each of the plurality of features represents at least a portion of a physical object in the physical environment. Thus, in various implementations, the plurality of features are detected using any object detection algorithm applied to the plurality of images. In various implementations, the plurality of features includes at least one point. For example, in FIG. 3A, in various implementations, the electronic device detects the corners of the top surface of the desk 213. In various implementations, the plurality of features includes at least one room corner. For example, in FIG. 3D, the electronic device detects the upper room corner formed by the intersection of the first wall 211A, the second wall 211B, and the ceiling 214. As another example, in FIG. 3G, the electronic device detects the lower room corner formed by the intersection of the second wall 211B, the third wall 211C, and the floor 217.

In various implementations, the plurality of features includes at least one line. For example, in FIG. 3G, the electronic device detects the room edge formed by the intersection of the second wall 211B and the third wall 211C. As another example, in FIG. 3C, the electronic device detects the room edge formed by the intersection of the first wall 211A and the ceiling. As another example, in FIG. 3C, the electronic device detects the top edge of the front of the laptop 212.

In various implementations, the plurality of features includes at least one surface. For example, in FIG. 3A, the electronic device detects the top surface of the desk 213. In various implementations, the plurality of features includes at least one wall. For example, in FIG. 3A, the electronic device detects the first wall 211A. In various implementations, the plurality of features includes at least one of a ceiling or a floor. For example, in FIG. 3G, the electronic device detects the ceiling 214 and the floor 217. In various implementations, the plurality of features includes at least one volume. For example, in FIG. 3G, the electronic device detects the bookcase 218. As another example, in FIG. 3D, the electronic device detects the lamp 215.

The method 400 continues, in block 430, with the device determining an enrollment score based on a number of the plurality of images and a number of the plurality of features. The method 400 continues, in block 440, with the device, in response to determining that the enrollment score is greater than a threshold, generating a mesh of the physical environment based on the plurality of images.

For example, in various implementations, the enrollment score is weighted sum of the number of the plurality of images and the number of the plurality of features. As another example, the enrollment score is formulated such that both the number of the plurality of images and the number of the plurality of features are greater than an image threshold and a feature threshold, respectively. For example, in various implementations, each of the detected features is a room corner and the enrollment score is greater than the threshold when the number of images is greater than 20 and at least four upper room corners and at least one lower room corners has been detected. As another example, in various implementations, each of the detected features is a room surface and the enrollment score is greater than the threshold when the number of images is greater than 30 and at least three walls and at least one of a floor or a ceiling have been detected.

In various implementations, determining the enrollment score is further based on a number of the plurality of images in which at least one of the plurality of features is detected. For example, in various implementations, the enrollment score is greater than the threshold when the number of images is greater than 50, the number of detected features is greater than 40, and at least 10 of the detected features are each detected in at least three different images.

In various implementations, determining the enrollment score is further based on a range of locations at which at least one of the plurality of features is detected in the plurality of images. For example, in various implementations, the enrollment score is greater than the threshold when the number of images is greater than 40, the number of detected features is greater than 75, and at least 30 of the features are detected in the top half of an image and in the bottom half of a different image.

In various implementations, the method 400 further comprises determining a field-of-view spanned by the plurality of images, wherein determining the enrollment score is further based on the field-of-view. In various implementations, the field-of-view is based on data from an inertial measurement unit (IMU) of the device. In various implementations, the field-of-view is based on analysis of the plurality of images. For example, in various implementations, the enrollment score is greater than threshold only when a horizontal field-of-view spanned by the plurality of images is greater than 300 degrees. As another example, in various implementations, the enrollment score is greater than the threshold only when a vertical field-of-view is greater than 180 degrees.

In various implementations, the method 400 further comprises determining an image quality of at least one of the plurality of images, wherein determining the enrollment score is further based on the image quality. For example, if the image quality of a particular image is low, the image and the detected features of the image would contribute less to the enrollment score.

In various implementations, a detected feature’s contribution to the enrollment score may be based on the type of feature. For example, a room corner may contribute more to the enrollment score than the corner of a desk or bookshelf. As another example, a wall may contribute more to the enrollment score than a surface of a desk.

In various implementations, generating the mesh includes determining, for at least a subset of the plurality of features, a respective location in the physical environment. Thus, the mesh includes a number of vertices associated with coordinates in a three-dimensional coordinate system and a number of edges between the vertices. In various implementations, the mesh further includes a number of faces bounded by the edges. In various implementations, the faces are associated with textures (e.g., color patterns) based on the plurality of images.

In various implementations, generating the mesh includes replacing plane-like objects with planes and/or replacing detected objects with known meshes of corresponding objects.

The mesh can be used to enable a wide range of user experiences. For example, virtual content can be overlaid on detected objects or surfaces. As another example, a virtual mirror can display part of the room that is not otherwise within the device’s field-of-view. As another example, the mesh can be transmitted to another user to experience the physical environment.

FIG. 5 is a block diagram of an example of the controller 110 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the controller 110 includes one or more processing units 502 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 506, one or more communication interfaces 508 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 510, a memory 520, and one or more communication buses 504 for interconnecting these and various other components.

In some implementations, the one or more communication buses 504 include circuitry that interconnects and controls communications between system components. In some implementations, the one or more I/O devices 506 include at least one of a keyboard, a mouse, a touchpad, a joystick, one or more microphones, one or more speakers, one or more image sensors, one or more displays, and/or the like.

The memory 520 includes high-speed random-access memory, such as dynamic random-access memory (DRAM), static random-access memory (SRAM), double-data-rate random-access memory (DDR RAM), or other random-access solid-state memory devices. In some implementations, the memory 520 includes non-volatile memory, such as one or more magnetic disk storage devices, optical disk storage devices, flash memory devices, or other non-volatile solid-state storage devices. The memory 520 optionally includes one or more storage devices remotely located from the one or more processing units 502. The memory 520 comprises a non-transitory computer readable storage medium. In some implementations, the memory 520 or the non-transitory computer readable storage medium of the memory 520 stores the following programs, modules and data structures, or a subset thereof including an optional operating system 530 and an XR experience module 540.

The operating system 530 includes procedures for handling various basic system services and for performing hardware dependent tasks. In some implementations, the XR experience module 540 is configured to manage and coordinate one or more XR experiences for one or more users (e.g., a single XR experience for one or more users, or multiple XR experiences for respective groups of one or more users). To that end, in various implementations, the XR experience module 540 includes a data obtaining unit 542, a tracking unit 544, a coordination unit 546, and a data transmitting unit 548.

In some implementations, the data obtaining unit 542 is configured to obtain data (e.g., presentation data, interaction data, sensor data, location data, etc.) from at least the electronic device 120 of FIG. 1. To that end, in various implementations, the data obtaining unit 542 includes instructions and/or logic therefor, and heuristics and metadata therefor.

In some implementations, the tracking unit 544 is configured to map the physical environment 105 and to track the position/location of at least the electronic device 120 with respect to the physical environment 105 of FIG. 1. To that end, in various implementations, the tracking unit 544 includes instructions and/or logic therefor, and heuristics and metadata therefor.

In some implementations, the coordination unit 546 is configured to manage and coordinate the XR experience presented to the user by the electronic device 120. To that end, in various implementations, the coordination unit 546 includes instructions and/or logic therefor, and heuristics and metadata therefor.

In some implementations, the data transmitting unit 548 is configured to transmit data (e.g., presentation data, location data, etc.) to at least the electronic device 120. To that end, in various implementations, the data transmitting unit 548 includes instructions and/or logic therefor, and heuristics and metadata therefor.

Although the data obtaining unit 542, the tracking unit 544, the coordination unit 546, and the data transmitting unit 548 are shown as residing on a single device (e.g., the controller 110), it should be understood that in other implementations, any combination of the data obtaining unit 542, the tracking unit 544, the coordination unit 546, and the data transmitting unit 548 may be located in separate computing devices.

Moreover, FIG. 5 is intended more as functional description of the various features that may be present in a particular implementation as opposed to a structural schematic of the implementations described herein. As recognized by those of ordinary skill in the art, items shown separately could be combined and some items could be separated. For example, some functional modules shown separately in FIG. 5 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

FIG. 6 is a block diagram of an example of the electronic device 120 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the electronic device 120 includes one or more processing units 602 (e.g., microprocessors, ASICs, FPGAs, GPUs, CPUs, processing cores, and/or the like), one or more input/output (I/O) devices and sensors 606, one or more communication interfaces 608 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 610, one or more XR displays 612, one or more optional interior- and/or exterior-facing image sensors 614, a memory 620, and one or more communication buses 604 for interconnecting these and various other components.

In some implementations, the one or more communication buses 604 include circuitry that interconnects and controls communications between system components. In some implementations, the one or more I/O devices and sensors 606 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more XR displays 612 are configured to provide the XR experience to the user. In some implementations, the one or more XR displays 612 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more XR displays 612 correspond to diffractive, reflective, polarized, holographic, etc. waveguide displays. For example, the electronic device 120 includes a single XR display. In another example, the electronic device includes an XR display for each eye of the user. In some implementations, the one or more XR displays 612 are capable of presenting MR and VR content.

In some implementations, the one or more image sensors 614 are configured to obtain image data that corresponds to at least a portion of the face of the user that includes the eyes of the user (any may be referred to as an eye-tracking camera). In some implementations, the one or more image sensors 614 are configured to be forward-facing so as to obtain image data that corresponds to the physical environment as would be viewed by the user if the electronic device 120 was not present (and may be referred to as a scene camera). The one or more optional image sensors 614 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 620 includes high-speed random-access memory, such as DRAM, SRAM, DDR RAM, or other random-access solid-state memory devices. In some implementations, the memory 620 includes non-volatile memory, such as one or more magnetic disk storage devices, optical disk storage devices, flash memory devices, or other non-volatile solid-state storage devices. The memory 620 optionally includes one or more storage devices remotely located from the one or more processing units 602. The memory 620 comprises a non-transitory computer readable storage medium. In some implementations, the memory 620 or the non-transitory computer readable storage medium of the memory 620 stores the following programs, modules and data structures, or a subset thereof including an optional operating system 630 and an XR presentation module 640.

The operating system 630 includes procedures for handling various basic system services and for performing hardware dependent tasks. In some implementations, the XR presentation module 640 is configured to present XR content to the user via the one or more XR displays 612. To that end, in various implementations, the XR presentation module 640 includes a data obtaining unit 642, a room enrollment unit 644, an XR presenting unit 646, and a data transmitting unit 648.

In some implementations, the data obtaining unit 642 is configured to obtain data (e.g., presentation data, interaction data, sensor data, location data, etc.) from at least the controller 110 of FIG. 1. To that end, in various implementations, the data obtaining unit 642 includes instructions and/or logic therefor, and heuristics and metadata therefor.

In some implementations, the room enrollment unit 644 is configured to determine a room enrollment score based a captured images and generate a mesh of a physical environment based on the captured images when the room enrollment score breaches a threshold. To that end, in various implementations, the room enrollment unit 644 includes instructions and/or logic therefor, and heuristics and metadata therefor.

In some implementations, the XR presenting unit 646 is configured to display, via the one or more XR displays 612, virtual content while the images are captured. To that end, in various implementations, the XR presenting unit 646 includes instructions and/or logic therefor, and heuristics and metadata therefor.

In some implementations, the data transmitting unit 648 is configured to transmit data (e.g., presentation data, location data, etc.) to at least the controller 110. In some implementations, the data transmitting unit 648 is configured to transmit authentication credentials to the electronic device. To that end, in various implementations, the data transmitting unit 648 includes instructions and/or logic therefor, and heuristics and metadata therefor.

Although the data obtaining unit 642, the room enrollment unit 644, the XR presenting unit 646, and the data transmitting unit 648 are shown as residing on a single device (e.g., the electronic device 120), it should be understood that in other implementations, any combination of the data obtaining unit 642, the room enrollment unit 644, the XR presenting unit 646, and the data transmitting unit 648 may be located in separate computing devices.

Moreover, FIG. 6 is intended more as a functional description of the various features that could be present in a particular implementation as opposed to a structural schematic of the implementations described herein. As recognized by those of ordinary skill in the art, items shown separately could be combined and some items could be separated. For example, some functional modules shown separately in FIG. 6 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a device including an image sensor, non-transitory memory, and one or more processors:
capturing, using the image sensor, a plurality of images of a physical environment;
detecting, in the plurality of images, a plurality of features;
determining an enrollment score based on a number of the plurality of images and a number of the plurality of features; and
in response to determining that the enrollment score is greater than a threshold, generating a mesh of the physical environment based on the plurality of images.

2. The method of claim 1, wherein capturing the plurality of images includes periodically capturing the plurality of images.

3. The method of claim 1, wherein capturing the plurality of images includes capturing the plurality of images in response to detecting motion of the device.

4. The method of claim 1, wherein each of the plurality of features represents at least a portion of a physical object in the physical environment.

5. The method of claim 1, wherein the plurality of features includes at least one point.

6. The method of claim 5, wherein the plurality of features includes at least one room corner.

7. The method of claim 1, wherein the plurality of features includes at least one line.

8. The method of claim 1, wherein the plurality of features includes at least one surface.

9. The method of claim 8, wherein the plurality of features includes at least one wall.

10. The method of claim 8, wherein the plurality of features includes at least one of a floor or a ceiling.

11. The method of claim 1, wherein the plurality of features includes at least one volume.

12. The method of claim 1, wherein determining the enrollment score is further based on a number of the plurality of images in which at least one of the plurality of features is detected.

13. The method of claim 1, wherein determining the enrollment score is further based on a range of locations at which at least one of the plurality of features is detected in the plurality of images.

14. The method of claim 1, further comprising determining a field-of-view spanned by the plurality of images, wherein determining the enrollment score is further based on the field-of-view.

15. The method of claim 14, wherein determining the field-of-view is based on data from an inertial measurement unit (IMU) of the device.

16. The method of claim 1, further comprising determining an image quality of at least one of the plurality of images, wherein determining the enrollment score is further based on the image quality.

17. The method of claim 1, wherein generating the mesh includes determining, for at least a subset of the plurality of features, a respective location in the physical environment.

18. The method of claim 1, wherein generating the mesh includes replacing plane-like objects with planes and/or replacing detected objects with known meshes of corresponding objects.

19. A device comprising:
an image sensor;
a non-transitory memory; and
one or more processors to:
capture, using the image sensor, a plurality of images of a physical environment;
detect, in the plurality of images, a plurality of features;
determine an enrollment score based on a number of the plurality of images and a number of the plurality of features; and
in response to determining that the enrollment score is greater than a threshold, generate a mesh of the physical environment based on the plurality of images.

20. A non-transitory memory storing one or more programs, which, when executed by one or more processors of a device including an image sensor, cause the device to:
capture, using the image sensor, a plurality of images of a physical environment;
detect, in the plurality of images, a plurality of features;
determine an enrollment score based on a number of the plurality of images and a number of the plurality of features; and
in response to determining that the enrollment score is greater than a threshold, generate a mesh of the physical environment based on the plurality of images.
